(19) United States
(12) Patent Application Publication
(10) Pub. No.: US 2010/0303580 A1
(43) Pub. Date: Dec. 2, 2010

(54) UNLOCKING-RESISTANT AND LOOSENING-RESISTANT NUT ASSEMBLY

(76) Inventor: MORRIES LIN, Rende Township (TW)

Correspondence Address: LEONG C. LEI, PMB # 1008, 1839 YGNACIO VALLEY ROAD, WALNUT CREEK, CA, 94598, US

(21) Appl. No.: 12/472,396

(22) Filed: May 27, 2009

(51) Int. Cl. F16B 39/10

(52) U.S. Cl. 411/198

(57) ABSTRACT

An unlocking-resistant and loosening-resistant nut assembly includes a conic nut and a wedge washer. The conic nut includes a conic portion, a force application portion, and a first wedge face formed on a bottom surface of the conic nut. The force application portion includes a hexagonal prism to enable force application thereto by a socket or open-ended wrench. The conic portion has a curved contour that shows a concave curve. The wedge washer includes a circular washer having a diameter greater than the conic nut. The wedge washer has a surface on which a second wedge face that corresponds in configuration to the first wedge face of the conic nut is circumferentially formed and an opposite surface forming at least one sharp fitting rib that has a cross-section comprising a right-angle having a hypotenuse extending in the direction of tightening the conic nut.

### TECHNICAL FIELD OF THE INVENTION

The present invention generally relates to an unlockig-resistant and loosening-resistant bolt structure, and particularly to a nut assembly comprising a nut structure that shows only a reduced force application surface for easy breaking after the nut is tightened in order prevent a regular hand tool from unlocking the nut.

### DESCRIPTION OF THE PRIOR ART

Referring to FIG. 1, a conventional nut assembly is shown. The conventional nut, which is broadly designated at 100, comprises a body 101 that shows a hexagonal configuration to enable force application thereto by a hand tool, such as a socket wrench or an open-ended wrench. The body 101 forms a central bore 102 having an inner circumference defining an inner thread 103. To secure two parts together, a threaded shank 111 of a bolt 110 is put through the two parts and a circular washer 120 of a uniform thickness is provided, whereby the two parts are securely fixed by engagement between the inner thread 103 of the nut 100 and an outer thread 112 of the bolt 110.

The conventional nut assembly is effective to secure two parts together. Yet, the nut 100, after being tightened, can be easily released through reverse rotation by a hand tool. Consequently, when it is desired to prevent these secured parts from being removed, it is generally not possible to prevent an unauthorized person from releasing the nut in situation. Apparently, resistance against unauthorized releasing of nut cannot be ensured. Further, a nut is often used in an environment where vibration occurs. The conventional nut, after subjected to vibration, will get loosened as being rotated step-by-step along the helix surface of the thread. Thus, resistance against undesired loosening of the nut cannot be ensured. Apparently, the conventional nut needs further improvements.

### SUMMARY OF THE INVENTION

In view of these problems occurring in the applications of the conventional nuts, the present invention aims to provide a nut assembly that overcomes these problems.

The primary objective of the present invention is to provide an unlocking-resistant and loosening-resistant nut assembly, which comprises a nut structure having a hand tool force application section that breaks after the nut is tightened by the hand tool, so that reverse rotation of the nut for unlocking by using a hand tool to hold the nut cannot be carried out.

To achieve the above objective, the present invention provides an unlocking-resistant and loosening-resistant nut assembly, which comprises a conic nut and a wedge washer, wherein the conic nut comprises a conic portion, a force application portion, and a first wedge face formed on a bottom surface of the conic nut. The force application portion comprises a hexagonal prism to enable force application thereto by a socket or open-ended wrench. The conic portion has a curved contour that shows a concave curve. The wedge washer comprises a circular washer having a diameter greater than the conic nut. The wedge washer has a surface on which a second wedge face that corresponds in configuration to the first wedge face of the conic nut is circumferentially formed and an opposite surface forming at least one sharp fitting rib that has a cross-section comprising a right-angle having a hypotenuse extending in the direction of tightening the conic nut.

In the nut assembly, the conic nut has an overall thickness corresponding to thickness specifications of M6 to M18 metric nuts and the force application portion has a thickness of which a thickness ratio with respect to the overall thickness is between 1:3 to 1:5.

In the nut assembly, the conic nut is subjected to no heat treatment for hardening.

In the nut assembly, the washer has hardness greater than the nut.

With the above discussed construction of the net in accordance with the present invention, the hexagonal configuration of the force application portion enables force application thereto to tighten the conic nut. Further, the present invention allows the force application portion to be broken by additionally applied force after the conic nut has been tightened and this, together with the conic configuration of the conic portion, effectively reduces the surface area where a tool can hold or clamp the nut to thereby realize the feature of resisting unlocking. When the nut has a tendency for reverse rotation, an interference force caused by mutual expelling action induced between the slope faces of the two wedge faces makes the engagement of the nut tighter, thereby realizing resistance against loosening. As such, the practicability of the nut assembly is enhanced.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view illustrating a conventional nut assembly.

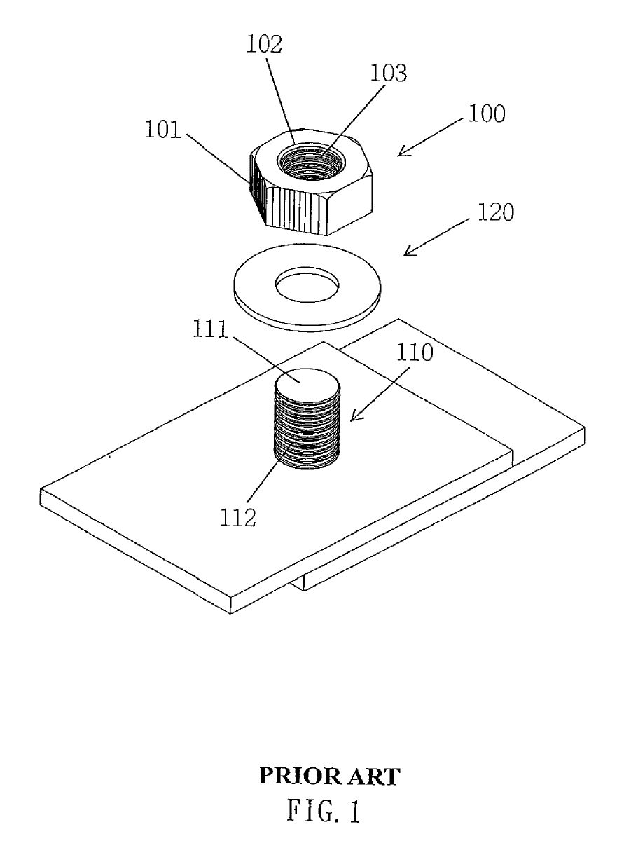

FIG. 2 is a perspective view showing a nut assembly in accordance with the present invention.

FIG. 3 is another perspective view of the nut assembly in accordance with the present invention taken at a different angle.

FIG. 4 is a side elevational view of the nut assembly of the present invention.

FIG. 5 is a plan view illustrating a force application portion of a conic nut of the present invention that is broken and no longer carries a hand tool.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

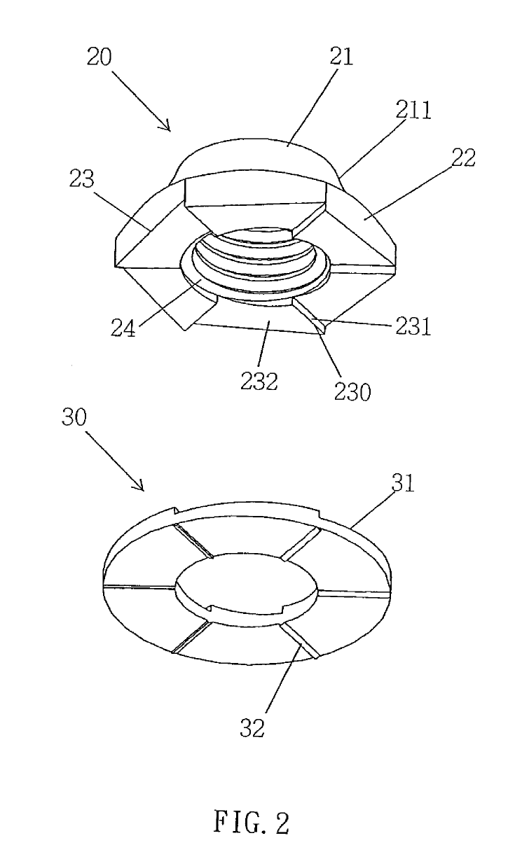

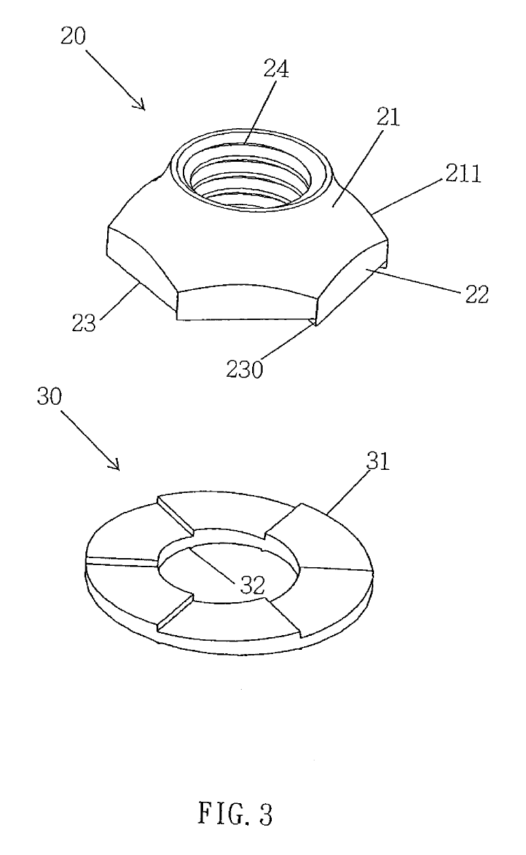

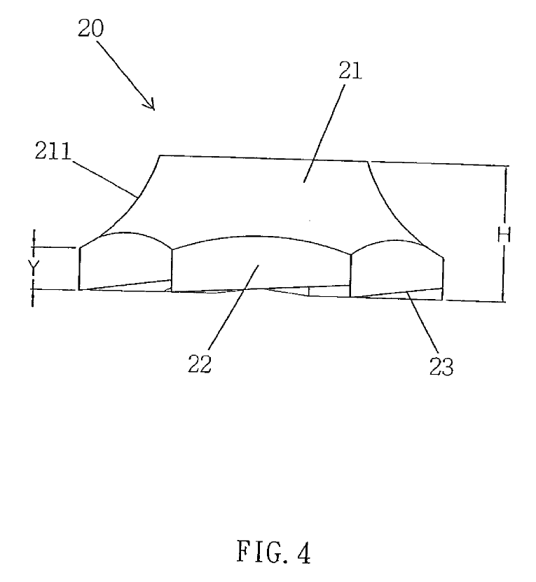

With reference to the drawings and in particular to FIGS. 2 and 3, a M8 nut of Metric Specification will be taken as an example to explain a preferred embodiment of the present invention. The drawings show a nut assembly in accordance with the present invention, which comprises a conic nut 20 and a wedge washer 30. The conic nut 20 is a mechanical part that is not subjected to heat treatment for hardening and shows only the inherent strength of the material making the nut. The conic nut 20 has a configuration that comprises a large-portion conic portion 21, a small-portion force application portion 22, and a first wedge face 23 formed on a bottom surface of the conic nut 20. The first wedge face 23 is formed by at least one one-way wedge-shaped tooth 230. The on-way wedge-shaped tooth 230 comprises a stop face 231 and a slope face 232. The force application portion 22 is in the form of a hexagonal prism with a reduced thickness to which a hand tool, such as a socket wrench or an open-ended wrench, applies a force. The conic portion 21 forms a curved contour 211, which is configured to show a concave curve extending from a position at a top face of the nut that is close to the bore 24 toward an outer circumference of the force application portion 22, so that, in the overall outer configuration, the force application portion 22 takes a large fraction or portion, but the force application portion 22 is still sized to carry the force applied thereto by a toll. As shown in FIG. 4, the force application portion 22 has a thickness Y that takes a given ratio of the thickness H of the nut 20so that Y:H=1:3. Taking an M8 metric nut having a thickness of 6.55 mm as an example, the force application portion 22 has a thickness of approximately 2.2 mm. The wedge washer 30 is a circular washer having a shape that has a diameter greater than the conic nut 20 and has a given hardness to reduce deformation when subjected to an external force. The wedge washer 30 has a surface on which a second wedge face 31 that is configured to correspond to the first wedge face 23 of the conic nut 20 is circumferentially formed and an opposite surface forming at least one sharp fitting rib 32. The fitting rib 32 has a cross-section that comprises a right-angle having a hypotenuse extending in the direction of tightening the conic nut 20.

With such an arrangement, when the conic nut 20 is tightened, the force application portion 22 that is of a reduced thickness enables the application of a hand tool thereto for rotation. The first wedge face 23 and the second wedge face 31 provided on the two constituent members engage each other in such a way that the stop faces thereof abut each other to allow synchronous rotation therebetween. With the conic nut 20 increasingly tightened, the wedge washer 30 applies to a workpiece to be secured a pressure that is gradually increased until no further rotation can occur. The fitting rib 32 piercingly fit into the workpiece. Since the material that makes the conic nut 20 is not subjected to heat treatment for hardening, and also due to the fact that the force application portion 22 has a reduced thickness, the force application portion 22 cannot support a high torque applied thereto. Thus, when force is continuously applied to the conic nut 20 after it has been tightened, corners of the force application portion 22 that directly take stresses induced by the hand tool may be broken, making the conic nut 20 no longer supporting the hand tool. Further, since the configuration of the conic nut 20 is substantially a cone having a concave curved side contour, the surface that the nut provides for supporting the hand tool is comparatively small by which resistance against unlocking can be realized. In addition, when the nut has a tendency for reverse rotation, mutual expelling action induced between the slope faces of the two wedge faces causes the fitting rib 32 on the surface of the wedge washer 30 that faces the workpiece to more deeply fit into and more tightly engage the workpiece, thereby realizing resistance against loosening.

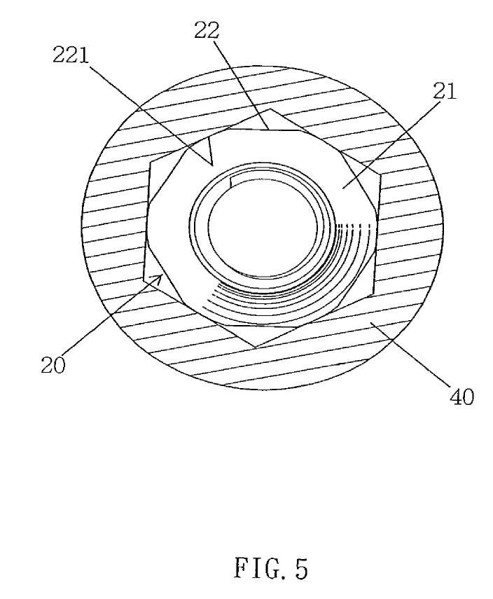

As shown in FIG. 5, in the above discussed construction provided by the present invention, the hexagonal configuration of the force application portion 22 is provided to enable application of force by a tool, such as a socket 40, to rotate and tighten the conic nut 20. The force application portion 22 is made in such a way to have the configuration thereof damaged by additional application of force after the conic nut 20 has been tightened. This, together with the conic configuration of the conic portion 21, effectively reduces the surface area of the nut that can support the force application of the tool so as to realize resistance against unlocking. Even the configuration of the force application portion 22 maintains intact, it is still very hard to use a tool alone to reversely rotate the conic nut 20 (the reason being the same as that for resistance against loosening). In other words, with excessive force application for reverse rotation, the force application portion 22 of the conic nut 20 may also be damaged of its configuration to further support force application thereto by the tool. If necessary, the nut can only be removed by being totally destructed. Although the force application portion of the conic nut in accordance with the present invention is made a hexagon of reduced thickness, yet it is different from a regularly-shaped hexagonal nut (bearing no conic portion) with a reduced thickness, because the thickness-reduced regular hexagonal nut cannot meet the requirement for carrying loading as specified by Metric Specification. In the above discussed embodiment, the M8 metric nut, as well as other metric nuts, such as M6 and M10 nuts, has a relatively small overall thickness and thus, the ratio between the force application portion 22 and the overall thickness can be for example 1:3 as discussed above. However, for those nuts, such as M12, M14, M16, and M18 metric nuts, having a relatively large overall thickness, the ratio between the force application portion 22 and the overall thickness can be made 1:5 to effectively reduce and restrict the thickness of the force application portion 22. Briefly speaking, for conic nuts offered by the present invention that has an overall thickness meet the thickness specification for M6 to M18 metric nuts, the ratio of the force application portion and the overall thickness can be selectively set between 1:3 to 1:5.

To summarize, the present invention provides a nut having an outer configuration of which a large portion forms a smooth cone, so that after the portion where force can be applied thereto is damaged, it is possible to prevent unauthorized person to unlock the nut by forcibly holding or clamping the nut, and thus providing a unlock-resistant feature, and the nut also features excellent resistance against undesired loosening of the nut.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An unlocking-resistant and loosening-resistant nut assembly comprising a conic nut and a wedge washer, characterized in that the conic nut comprises a conic portion, a force application portion, and a first wedge face formed on a bottom surface of the conic nut, the force application portion being a hexagonal prism to enable force application thereto by a socket or open-ended wrench, the conic nut having an overall thickness corresponding to thickness specifications of M6 to M18 metric nuts, the force application portion having a thickness of which a thickness ratio with respect to the overall thickness is between 1:3 to 1:5, the conic portion having a curved contour that shows a concave curve,
the wedge washer comprising a circular washer having a diameter greater than the conic nut, the wedge washer having a surface on which a second wedge face that is configured to correspond to the first wedge face of the conic nut is circumferentially formed and an opposite surface forming at least one sharp fitting rib that has a cross-section comprising a right-angle having a hypotenuse extending in the direction of tightening the conic nut.

2. The unlocking-resistant and loosening-resistant nut assembly according to claim 1, wherein the conic nut is subjected to no heat treatment for hardening.

3. The unlocking-resistant and loosening-resistant nut assembly according to claim 1, wherein the first wedge face formed at least one one-way wedge-shaped tooth, which comprises a stop face and a slope face.

4. The unlocking-resistant and loosening-resistant nut assembly according to claim 1, wherein the washer has hardness greater than the nut.
